(19) United States
(12) Patent Application Publication
(10) Pub. No.: US 2023/0267061 A1
(43) Pub. Date: Aug. 24, 2023

(54) INFORMATION TECHNOLOGY ISSUE SCORING AND VERSION RECOMMENDATION

(71) Applicant: BugZero LLC, Denver, CO (US)

(72) Inventor: Eric DEGRASS, Denver, CO (US)

(21) Appl. No.: 18/111,293

(22) Filed: Feb. 17, 2023

Related U.S. Application Data
(60) Provisional application No. 63/311,769, filed on Feb. 18, 2022.

(51) Int. Cl. G06F 11/34; G06F 8/71

(52) U.S. Cl. CPC G06F 11/3452; G06F 8/71

(57) ABSTRACT

In examples, vulnerability information is obtained from vendors/manufacturers and/or centralized data sources and processed to extract information about associated issues. Additionally, one or more scores (e.g., a confidentiality score, an availability score, and/or an integrity score) may be generated for hardware and/or software based on a set of associated issues. A score may be version-specific, such that different versions of software may each have different associated scores. A set of generated scores may each be used as a score component to generate an aggregated score for the hardware and/or software (e.g., by weighting security and/or operational issues differently). In some instances, an organization may prioritize confidentiality over availability or vice versa, such that an aggregated score reflects a user-configured weighting. Aggregated scores for multiple hardware and/or software versions may be ranked or presented to a user, thereby enabling a user to determine whether one version is preferable to another version.

### CROSS-REFERENCE TO RELATED APPLICATIONS

This application claims priority to U.S. Provisional Patent Application No. 63/311,769, titled “Information Technology Issue Scoring and Version Recommendation,” filed Feb. 18, 2022, the entirety of which is incorporated by reference herein.

### BACKGROUND

Computer software and/or hardware may have one or more associated issues that affect the confidentiality, integrity, and/or availability of the computing device and the data hosted on or served by the computing device. However, identifying and managing such issues may be difficult, especially in instances where a set of associated issues varies by software and/or hardware version, over time (e.g., issues may be patched or other mitigations may be identified), and depending on the environment in which the computing device is used, among other examples.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to obtaining and processing issue information associated with computer software and/or hardware. In examples, vulnerability information is obtained from vendors/manufacturers and/or centralized data sources, among other examples, and processed to extract information about associated issues. Additionally, one or more scores (e.g., a confidentiality score, an integrity score, and/or an availability score) may be generated for hardware and/or software based on a set of associated issues. In some instances, a score may be version-specific, such that different versions of software may each have different associated scores.

In examples, the generated scores may each be a score component used to generate an aggregated score for the hardware and/or software (e.g., by weighting confidentiality, integrity, and/or availability issues differently). In some instances, an organization may prioritize integrity and/or availability over confidentiality or vice versa (or any other combination thereof), such that an aggregated score reflects a set of user-configured weights. Aggregated scores for multiple hardware and/or software versions may be ranked or presented to a user, thereby enabling a user to determine whether one version is preferable to another version.

This overview is provided to introduce a selection of concepts in a simplified form that are further described below in the Detailed Description. As such, it is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates an overview of an example system for computer issue scoring and version recommendation generation.

FIG. 2 illustrates an overview of an example method for processing issue information according to aspects described herein.

FIG. 3 illustrates an overview of an example method for generating an aggregated score based on customer information according to aspects described herein.

FIG. 4 illustrates an overview of an example method for generating and implementing a recommendation based on an aggregated score according to aspects described herein.

FIG. 5 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a computing device may have one or more associated issues, including, but not limited to, confidentiality issues (e.g., affecting data security, access controls, and/or keeping data private), integrity issues (e.g., resulting in data loss, data corruption, and/or a reduction in or loss of the ability to audit computer usage), and/or availability issues (e.g., impacting functionality, stability, redundancy, uptime, performance, and/or quality of service). Such issues may result from one or more bugs, defects, vulnerabilities, exposures, and/or glitches, among other examples. Thus, it will be appreciated that an issue may affect any combination of hardware and/or software. Additionally, such issues may arise from any of a variety of underlying or related issues, including, but not limited to, security issues (e.g., exploits and/or privilege escalation vulnerabilities), vendor hardware and/or software quality issues, end-of-life (EOL) and/or end-of-support (EOS) issues, interoperability issues (e.g., resulting from a combination of multiple instances of hardware and/or software, as compared to a “primary” issue relating to a single instance of hardware and/or software), and/or misconfiguration issues (e.g., where an instance of hardware and/or software may otherwise not exhibit an issue but for a misconfiguration).

However, managing these and other issues may be difficult, especially in instances where a computing environment includes multiple computing devices that may each have an associated set of issues. Additionally, issues may vary according to a given software and/or hardware version, over time (e.g., as a result of identifying solutions), and/or in response to changes to the computing environment, among other examples. As a result, managing a level of risk associated with the computing environment (e.g., with respect to a confidentiality risk, an integrity risk, and/or an availability risk) may be difficult. Similarly, it may be difficult to make decisions about what software and/or hardware to use in a given computing environment, such as whether a specific hardware and/or software version should be used or whether the hardware and/or software should be used in the computing environment at all.

Accordingly, aspects of the present application relate to computer issue scoring and version recommendation. In examples, issue information is obtained and processed to identify a set of issues. One or more scores may be generated for an identified issue according to aspects described herein, including a confidentiality score, an integrity score, and/or an availability score, among other examples. Customer information (e.g., as may be obtained from a configuration management database (CMDB)) may be processed to generate a set of issues associated with software and/or hardware of the customer.

In examples, a computing device may have multiple associated issues (e.g., including a set of confidentiality issues, a set of integrity issues, and/or a set of availability issues). Accordingly, an aggregated score may be generated for the computing device (e.g., with respect to one or more pieces of software, one or more hardware components, and/or a combination thereof). In examples, the aggregated score is generated based on multiple confidentiality, integrity, and/or availability scores, thereby providing a user with an indication as to an aggregated or overall risk associated with the hardware and/or software.

In some instances, at least a part of the aggregated score generation is user-configurable, for example to enable a customer to configure a set of weights placed on one or more constituent score components from which the aggregated score is generated. For instance, a first customer may place a higher priority on availability as compared to confidentiality, such that an aggregated score generated for the first customer may weight an availability score component higher than a confidentiality score component. As another example, a second customer may place a higher priority on integrity as compared to availability, such that an aggregated score generated for the second customer may weight an integrity score component higher than an availability score component. In a further example, a customer may place a higher priority on confidentiality, integrity, and/or availability of one or more types of devices (e.g., networking infrastructure, storage infrastructure, communication infrastructure, virtualization infrastructure, etc.).

Thus, different customers may each be presented with different aggregated scores for the same or a similar set of computing devices, thereby enabling each respective customer to make an individual and/or personalized assessment as to a level of risk associated with hardware, software, and/or one or more computing devices of the customer. It will be appreciated that any of a variety of additional or alternative weighting, filtering, and/or ranking techniques may be used. For example, issues may be weighted, ranked, and/or filtered based at least in part on an associated service and/or status. As an example, a user may indicate to filter or deemphasize issues associated with a given service (e.g., Quality of Service (QoS), DHCP Server, Network Manager, etc.), as may be the case when the service is not used or is not critical to a given computing environment. For example, a customer may indicate to omit or deemphasize issues with a status of “terminated” or “low,” respectively. Further, while examples are described herein with respect to a specific computing device, instance of hardware, and/or instance of software, it will be appreciated that the present aspects are applicable to evaluate one or more risks associated with any of a variety of devices, software, and/or hardware, or any combination thereof.

It will be appreciated that score generation need not be limited to a computing environment currently in use by a customer. Rather, similar techniques may be used to generate information for planning purposes (e.g., when considering to upgrade hardware and/or software or when adding new computing devices to the computing environment) or for the purpose of historical analysis (e.g., to determine whether the state of a current environment is an improvement or a regression as compared to the state of a previous environment). For example, one or more scores may be generated for each version of a set of versions associated with software and/or hardware, thereby enabling a user to consider whether a different version may reduce a risk associated with the computing environment. In examples, a generated risk score and/or additional associated information is presented as part of a change management process, for example to display a risk score for a change to hardware and/or software or to display a change to an associated risk score that would result if the change is implemented, among other examples.

In such an example, an aggregated score may be generated for each version and presented to a user, thereby enabling a quantified and/or analytical approach to comparing and ultimately selecting a version from a set of available versions associated with a computing device. In examples, a user may select a version based at least in part on an associated score, such that the computing device may be configured according to the selected version (e.g., upgrading, downgrading, or patching associated software) and/or associated hardware may be ordered from a vendor/manufacturer, among other examples.

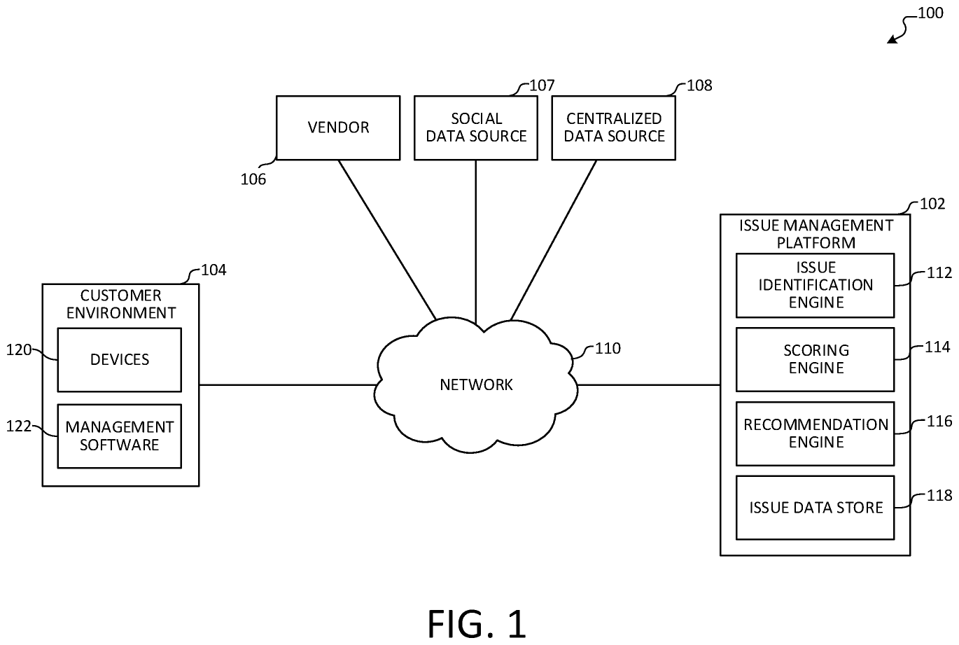

FIG. 1 illustrates an overview of an example system 100 for computer issue scoring and version recommendation generation. As illustrated, system 100 comprises issue management platform 102, customer environment 104, vendor 106, social data source 107, centralized data source 108, and network 110. In examples, issue management platform 102, customer environment 104, vendor 106, social data source 107, and/or centralized data source 108 communicate via network 110, which may comprise a local area network, a wireless network, or the Internet, or any combination thereof, among other examples.

Issue management platform 102 is illustrated as comprising issue identification engine 112, scoring engine 114, recommendation engine 116, and issue data store 118. In examples, issue management platform 102 is comprised of one or more computing devices. Issue identification engine 112 may obtain and process issue information according to aspects of the present disclosure. For example, issue identification engine 112 may obtain issue information from vendor 106, centralized data source 108, and/or customer environment 104, among other examples.

As an example, issue identification engine 112 may access a website of vendor 106 and/or receive an electronic communication from vendor 106. In another example, issue identification engine 112 access information from social data source 107, which may include associated discussion threads and/or a number of search results that are available from data source 107. Thus, social data source 107 may be a social media network, a discussion platform, a software version management platform, an online community, and/or a troubleshooting platform, among other examples. As a further example, centralized data source 108 may be a repository of issue information, as may have been submitted to centralized data source 108 by one or more vendors (e.g., vendor 106). As a further example, issue information may be identified from one or more support cases associated with vendor 106. In some instances, issue information obtained from vendor 106 and/or social data source 107 may predate similar issue information that is ultimately available from centralized data source 108, thereby enabling earlier identification of an issue than would otherwise be possible.

Thus, it will be appreciated that issue information may be obtained from a variety of sources, including, but not limited to, vendors/manufacturers, centralized data sources (e.g., the National Vulnerability Database and/or the Open Source Vulnerability Database), crowd-sourced data sources, and/or based on information obtained from one or more customer computing devices (e.g., bug reports, crash reports, or logs). Further, while example sources and associated information are described herein, it will be appreciated that any of a variety of additional or alternative such sources/information may be used in other examples.

Issue identification engine 112 processes issue information to generate one or more issues associated therewith. For example, issue identification engine 112 may generate an issue associated with one or more associated instances of computer hardware and/or software (and/or more specifically associated with one or more affected versions). The issue may include a reported issue severity, and/or one or more remediation or mitigation actions, among additional or alternative issue attributes. The generated issue may be stored in issue data store 118. Similar techniques may be used to update an existing issue in issue data store 118, as may be the case when another version is determined to exhibit a similar issue or a remediation action is identified for an existing issue, among other examples.

Issue identification engine 112 may perform issue disambiguation/deduplication, for example to determine whether an issue is substantially similar to or is a duplicate of another issue (e.g., as may exist within the obtained issue information and/or as may already be stored by issue data store 118). As another example, a vendor, manufacturer, or product name associated with an issue may change over time, such that an association between an old vendor and a new vendor (and/or manufacturer/product) may be identified and used to update an associated issue accordingly. In some instances, such disambiguation/deduplication may be performed using a machine learning model (e.g., as may have been trained using annotated issue data for a set of known vendors/manufacturers/products) and/or a set of rules (e.g., using exact, inexact, or fuzzy matching rules to associate similar issue information together).

In examples, issue identification engine 112 enriches a generated issue based on additional information (e.g., as may be generated and/or obtained by issue management platform 102 and/or as may be received from a user associated with issue management platform 102). For example, issue identification engine 112 may process one or more issue attributes that were determined from the obtained issue information to generate additional information based on a machine learning model and/or a set of rules (e.g., to classify the issue according to severity and/or to associate the issue with one or more instances of hardware and/or software).

As another example, issue identification engine 112 may identify additional information associated with the issue from any of a variety of other sources. For instance, an issue may be determined based on information from vendor 106, such that additional information may be obtained from social data source 107 and/or centralized data source 108 or any other combination thereof. For instance, such additional information may be processed using sentiment analysis and/or to determine a scope for the issue (e.g., a number of support cases for an issue, a number of page views for an associated knowledgebase article and/or database entry, an amount of user account comments on the issue, an amount of affected hardware/software instances, etc.), which may thus affect a score generated by scoring engine 114 accordingly. It will therefore be appreciated that any of a variety of techniques may be used to process such additional information accordingly.

Issue management platform 102 is further illustrated as comprising scoring engine 114. In examples, scoring engine 114 generates a confidentiality score, an integrity score, and/or an availability score for one or more issues (e.g., as may be stored in issue data store 118). Scoring engine 114 may provide a generated score in response to a request indicating one or more instances of computer hardware and/or software (e.g., as may be received from management software 122).

As an example, issues may be stored in association with one or more instances of computer hardware and/or software within issue data store 118, such that scoring engine 114 generates a score for the computer hardware and/or software based on a set of associated issues. In another example, scoring engine 114 may receive an indication of a given instance of hardware and/or software, such that scoring engine may identify a set of associated issues based on the received indication. Similar to the issue disambiguation/deduplication aspects described above, scoring engine 114 may utilize matching logic to identify a set of issues associated with a given instance of hardware and/or software. It will thus be appreciated that any of a variety of techniques may be used to identify a set of issues for which scoring engine 114 may generate a score.

As an example, scoring engine 114 may process each issue of the set of issues to generate a confidentiality score, an integrity score, and/or an availability score for the set according to aspects of the present disclosure. For example, each issue may have an associated severity and/or an issue probability (e.g., a number of vendor support cases divided by the total number of customers and/or associated installations), such that the resulting score is determined based at least in part on a weighting of the severity and/or probability associated with each respective issue. It will be appreciated that additional or alternative issue attributes may be used in other examples. As discussed above, a confidentiality, integrity, and/or availability score may be generated based on one or more underlying or related issues. For example, a security issue may affect both a confidentiality score and an availability score. As another example, a misconfiguration issue may affect both an integrity score and an availability score.

In some instances, scoring engine 114 evaluates a remediation/mitigation action associated with an issue (e.g., the availability of a patch, upgrade, and/or workaround such as disabling a service or avoiding certain functionality), such that the severity of the issue may be decreased as a result of the existence of a remediation/mitigation action and/or the ease with which the remediation/mitigation action may be performed. In addition to such remediating factors that may decrease a severity associated with an issue, scoring engine 114 may evaluate one or more extenuating factors, thereby increasing a severity of an issue. For example, if it is determined that an EOL or EOS date is approaching (e.g., within a predetermined threshold) for a given instance of hardware and/or software (and/or a version thereof), a severity of an associated issue may be increased. As another example, the proximity of an EOL/EOS date may have an increasing impact on the issue severity as the date becomes closer in time. While example remediating and extenuating factors are described, it will be appreciated that any of a variety of additional or alternative factors may be used to adapt a severity associated with an issue in other examples.

Thus, scoring engine 114 may generate a confidentiality score, an integrity score, and/or an availability score for the set of issues, where each score is an aggregated metric for the set of issues based on one or more issue attributes for each respective issue of the set. Additionally, scoring engine 114 may generate an aggregated score by weighting a generated confidentiality score, integrity score, and/or availability score. For example, the aggregated score may place a substantially equal weight on each score component. In another example, a greater weight may be given to a confidentiality score component as compared to an integrity and/or availability score component, as may be the case when a customer places a higher priority on confidentiality as compared to other types of risk. The set of weights used when generating an aggregated score may be user-configurable, as discussed above. For example, a set of weights may be associated with customer environment 104, which may differ from a set of default weights and/or a set of weights associated with another customer environment (not pictured), among other examples.

Recommendation engine 116 may generate a set of recommendations based on a score generated by scoring engine 114. For example, a recommendation request may be received (e.g., from management software 122), which may indicate one or more instances of computer hardware and/or software for which a version recommendation should be generated. Accordingly, recommendation engine 116 may determine a set of versions and associated scores (e.g., as may have been generated by scoring engine 114) associated with the computer hardware and/or software. In examples, recommendation engine 116 evaluates a set of versions based on an aggregated score for each version, such that the set of versions may be ranked according to the aggregated score associated with each version (e.g., which may be user-configurable, as discussed above). Accordingly, recommendation engine 116 may provide an indication of the highest-ranked version or, as another example, a number of highest-ranked versions (e.g., above a predetermined threshold or according to a predetermined or requested number of versions). In some instances, recommendation engine 116 provides information associated with each version, such as an aggregated score associated with the version, one or more score components from which the aggregated score was generated, and/or one or more associated issues.

For example, a version recommendation may be provided that includes an indication as to a recommended version, an aggregated score for the version, a confidentiality, integrity, and/or availability score, and/or associated issues from which the one or more scores was generated. Accordingly, a user may be presented with a set of issues associated with the recommended version, including an issue severity, known remediation/mitigation actions, and/or an indication as to whether the issue affects confidentiality, integrity stability, and/or availability, among other issue attributes.

In examples, an indication may be received to adjust weights with which an aggregated score was generated, such that an updated recommendation may be generated and provided accordingly. As another example, an indication may be received to upgrade/downgrade an instance of software according to the recommended version or to order a different hardware version, among other examples, such that issue management platform 102 may perform an action associated with the version recommendation accordingly. In some examples, the action may be performed in response to user input (e.g., to accept or to modify a recommendation).

System 100 is further illustrated as comprising customer environment 104. As used herein, a “customer” may be an individual, institution, business, or other entity that owns, operates, and/or otherwise manages a device or software supplied by a vendor. Customer environment 104 includes devices 120, which may comprise any of a variety of computing devices, including, but not limited to, a gateway, a router, a switch, a firewall device, a server device, a desktop computing device, a laptop computing device, a tablet computing device, and/or a mobile computing device, among other examples.

Management software 122 may maintain customer information associated with devices 120 of customer environment 104. For example, each device of customer environment 104 may have an associated customer information (CI) record that comprises properties of the device, including, but not limited to, a manufacturer, a model and/or serial number, current and/or previous software versions, and/or configuration details, among other properties. Management software 122 may provide an indication of at least a part of a CI record to issue management platform 102, such that associated issues may be identified, one or more scores may be obtained, and/or one or more version recommendations may be received according to aspects disclosed herein, among other examples.

Thus, a user may use management software 122 to view one or more aggregated scores and/or one or more confidentiality scores, integrity scores, and/or availability scores associated with devices 120. Similarly, management software 122 may be used to view information associated with such scores, such as one or more issue attributes and/or version recommendations according to aspects described herein. Management software 122 may be software associated with issue management platform 102 or may be a web browser used to access a website of issue management platform 102, among other examples.

It will be appreciated that system 100 is provided as an example environment in which aspects of the present application may be practiced. In other examples, customer environment 104 may comprise aspects described above with respect to issue management platform 102, or vice versa. As an example, management software 122 may include aspects discussed above with respect to issue identification engine 112, scoring engine 114, recommendation engine 116, and/or issue data store 118. As another example, issue management platform 102 may include aspects discussed above with respect to customer environment 104.

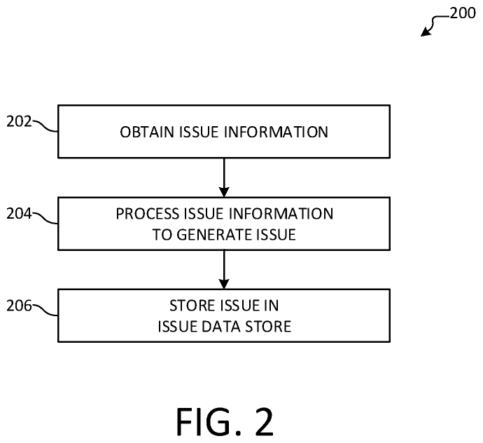

FIG. 2 illustrates an overview of an example method 200 for processing issue information according to aspects described herein. In examples, aspects of method 200 are performed by an issue identification engine, such as issue identification engine 112 of issue management platform 102 discussed above with respect to FIG. 1.

Method 200 begins at operation 202, where issue information is obtained. For example, the issue information may be obtained from a vendor (e.g., vendor 106 in FIG. 1), a centralized data source (e.g., centralized data source 108), and/or any of a variety of other sources. The issue information may comprise an indication as to an issue severity, one or more affected instances of hardware and/or software (and/or versions), and/or one or more associated remediation/mitigation actions, among other issue attributes.

At operation 204, the issue information is processed to generate an issue. As discussed above, processing the issue information may comprise disambiguating/deduplicating the issue information, enriching the issue information as a result of processing performed at operation 204, and/or enriching the issue information based on additional information identified from one or more other data sources (e.g., social data source 107 in FIG. 1). In examples, operation 204 comprises identifying a pre-existing issue in an issue data store, such that method 200 updates the pre-existing issue accordingly.

Flow progresses to operation 206, where the issue is stored in an issue data store (e.g., a known-error database such as issue data store 118, which was discussed above with respect to FIG. 1). In examples, the issue is stored in association with one or more instances of computer hardware and/or software, thereby enabling subsequent retrieval of the issue and associated issue attributes (e.g., to generate an one or more scores and/or version recommendations associated therewith). As noted above, operation 206 may comprise updating a pre-existing issue, for example by adding additional issue attributes, updating existing issue attributes, and/or removing issue attributes, among other examples. Method 200 terminates at operation 206.

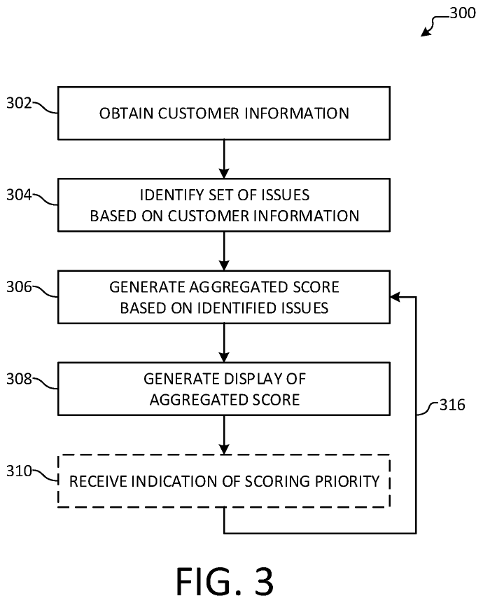

FIG. 3 illustrates an overview of an example method 300 for generating an aggregated score based on customer and/or vendor information according to aspects described herein. In examples, aspects of method 300 are performed by a scoring engine, such as scoring engine 114 discussed above with respect to FIG. 1. In examples, aspects of method 300 may be performed in response to a request for an aggregated score (e.g., as may be received from management software such as management software 122). As another example, aspects of method 300 may be performed periodically and/or in response to a change to a computing environment (e.g., a configuration change to one or more of devices 120). In a further example, aspects of method 300 may be performed in response to obtaining new or updated information from a vendor (e.g., vendor 106), a social data source (e.g., social data source 107), a centralized data source (e.g., centralized data source 108), and/or a variety of other data sources.

Method 300 begins at operation 302, where customer information is obtained. As an example, the customer information may be received from management software, such as management software 122 of customer environment 104 discussed above with respect to FIG. 1. In another example, the customer information may be obtained from a CMDB, a vendor portal (e.g., which may obtain information from a set of computing devices, such as version information and configuration information), or may be stored by an issue management platform (issue management platform 102), among other examples. Thus, it will be appreciated that customer information may be obtained from a variety of sources. The customer information may include information about one or more computing devices of a customer (e.g., as may be represented by one or more CI records).

Flow progresses to operation 304, where a set of issues is identified based on the obtained customer information. For example, the set of issues may be identified from an issue data store (e.g., issue data store 118 in FIG. 1), where each issue is identified based on an association with an instance of computer hardware and/or software specified by the customer information. The identified issues may be specific to a version, as may have been indicated by the customer information.

At operation 306, an aggregated score is generated based on the identified issues. As an example, the aggregated score may be generated according to a confidentiality score component, an integrity score component, and/or an availability score component, among other examples. Each score component may be weighted according to a set of default weights, a set of customer-specified weights (e.g., as may be associated with the customer or as may have been obtained at operation 302), and/or according to a set of rules, among other examples. In examples, operation 306 comprises generating each score component or, as another example, one or more of the score components may be pre-generated (e.g., as may have been generated as part of operation 204 discussed above with respect to method 200 in FIG. 2). As discussed above, each score component may be associated with multiple issues, for example thereby providing an aggregated confidentiality score component, an aggregated integrity score component, and/or an aggregated availability score component from which the aggregated score for the set of issues is generated.

Moving to operation 308, a display of the aggregated score is generated. In examples, operation 308 comprises providing an indication of the aggregated score to a computing device, such that the computing device may display the aggregated score accordingly. In examples, the aggregated score is displayed in association with one or more score components and/or associated issues, thereby enabling a user to evaluate the information from which the aggregated score was generated. As another example, operation 308 may comprise receiving and processing requests for such information. For example, a request may be received for additional information associated with an aggregated score, such that the requested additional information may be provided for display in response to the received request. In an example, the aggregated score and/or associated information may be displayed by an issue management platform, as part of a vendor portal, or in any of a variety of other contexts.

In an example, flow progresses to operation 310, where an indication of scoring priority is received. For example, the indication may indicate a change to one or more weights with which the aggregated score was generated. Accordingly, flow returns to operation 306 (as illustrated by arrow 316), such that an updated aggregated score is generated and ultimately provided at operation 308. Operation 310 is illustrated using a dashed box to indicate that, in other examples, operation 310 may be omitted. Method 300 terminates at operation 308.

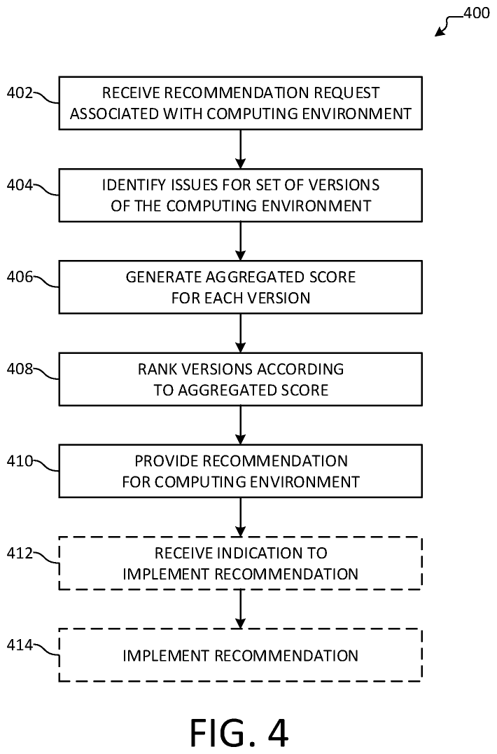

FIG. 4 illustrates an overview of an example method 400 for generating and implementing a recommendation based on an aggregated score according to aspects described herein. In examples, aspects of method 400 are performed by a recommendation engine, such as recommendation engine 116 discussed above with respect to FIG. 1.

Method 400 begins at operation 402, where a recommendation request associated with a computing environment is received. For example, the recommendation request may be received from management software, such as management software 122 of customer environment 104. The recommendation request may comprise an indication as to one or more computing devices and/or associated instances of software and/or hardware. In examples, the request is for a computing device of the environment or, as another example, may be for prospective hardware/software. Thus, it will be appreciated that the aspects described herein may be used in a hypothetical fashion and need not be limited to customer environments as they currently are.

At operation 404, issues are identified for a set of versions of the computing environment. For example, each instance of hardware and/or software may have an associated set of versions, such that a set of issues may be determined for each version. In examples, the issues are identified from an issue data store, such as issue data store 118 discussed above with respect to FIG. 1.

Flow progresses to operation 406, where an aggregated score is generated for each version. Aspects of operation 406 may be similar to those discussed above with respect to operation 306 and are therefore not necessarily re-described in detail. For example, operation 406 may include generating one or more score components from which the aggregated score is generated. As noted above, the aggregated score may be generated according to user-configurable weights and/or rules, among other examples.

Moving to operation 408, the set of versions is ranked according to the aggregated score associated with each version. While examples are described herein with respect to ranking versions according to an aggregated score, it will be appreciated that similar techniques may be used to rank versions according to an associated confidentiality, integrity, and/or availability score, for example thereby providing a recommendation based on an aggregated confidentiality score, aggregated integrity score, and/or an aggregated availability score, among other examples.

At operation 410, a recommendation for the computing environment is provided. The recommendation may comprise one or more highest-ranked versions, as were determined at operation 408. In examples, the recommendation includes information with which the aggregated score was generated, including a set of score components and/or one or more associated issues and/or issue components, among other examples. In examples, method 400 terminates at operation 410.

In other examples, method 400 progresses to operation 412, where an indication is received to implement a recommendation. For example, the indication may comprise acceptance of the recommendation that was provided at operation 410 or may comprise a selection from a set of versions that was provided at operation 410, among other examples. Accordingly, flow progresses to operation 414, where the recommendation is implemented. For example, operation 414 may comprise upgrading or downgrading an instance of software or placing an order for one or more hardware components, among other examples. Method 400 terminates at operation 414.

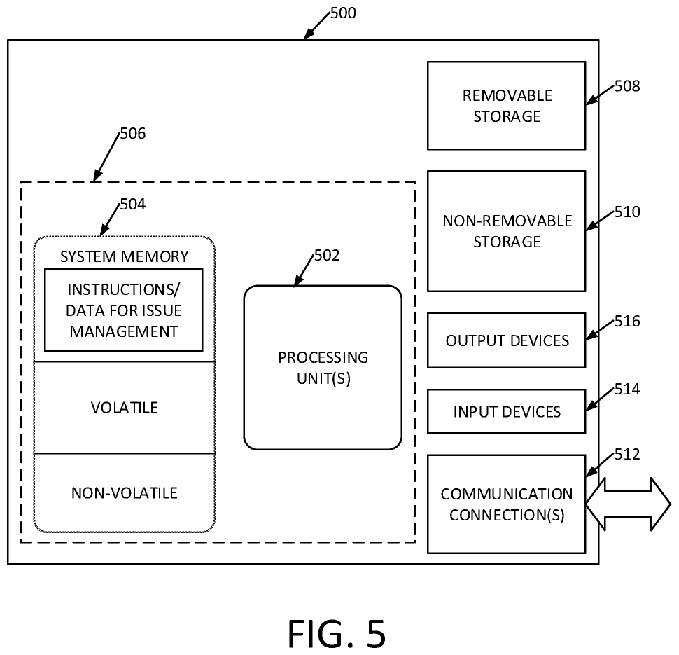

FIG. 5 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, business software such as enterprise resource planning (“ERP”, e.g. SAP and Oracle), public cloud platforms like Amazon Web Services and Microsoft Azure, networking equipment, storage systems, hyperconverged infrastructure (Nutanix), virtualization software like VMware, database systems, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein such as the methods illustrated in FIG. 2, 3, or 4, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: obtaining customer information indicating at least one of hardware or software, wherein the hardware or software has a corresponding version; identifying a set of issues associated with the version, wherein the set of issues includes two or more of a confidentiality issue, an integrity issue, and an availability issue; generating an aggregated score for the version based on the set of issues; and providing an indication of the aggregated score for the version. In an example, providing the indication of the aggregated score further comprises providing an indication of at least one issue of the identified set of issues. In another example, the aggregated score is generated based on one or more of: a confidentiality score component for the confidentiality issue; an integrity score component for the integrity issue; and an availability score component for the availability issue. In a further example, the aggregated score is generated based on a set of user-configured weights including at least one of: a first weight for the confidentiality score component; a second weight for the integrity score component; and a third weight for the availability score component. In yet another example, the set of issues relates to at least one of: a vulnerability for the version; or an operational defect for the version. In a further still example, the aggregated score is generated based on information obtained from at least one of: a vendor of the hardware or the software; a centralized data source; or a crowd-sourced data source. In another example, the customer information is obtained as part of a request, from a computing device, for an issue score associated with the at least one of hardware or software; and the set of operations further comprises providing the indication of the aggregated score for the version to the computing device in response to the request.

In another aspect, the technology relates to another system, comprising: at least one processor; and memory storing instructions that, when executed by the at least one processor, causes the system to perform a set of operations. The set of operations comprises: receiving a recommendation request comprising an indication of at least one of computer software or computer hardware; identifying, based on the recommendation request, a set of versions; generating, for each version of the set of versions, an aggregated score; ranking the set of versions based on an associated aggregated score for each version; and providing an indication of a highest-ranked version from the ranked set of versions. In an example, providing the indication of the highest-ranked version further comprises providing an indication of an aggregated score for the highest ranked version. In another example, providing the indication of the highest-ranked version further comprises providing an indication of a set of score components used to generate the aggregated score for the highest-ranked version. In a further example, generating the aggregated score for each version comprises: determining set of score components comprising two or more of: a confidentiality score component for the version; an integrity score component for the version; and an availability score component for the version; and generating the aggregated score based on a set of user-configurable weights, wherein each weight of the set of user-configurable weights corresponds to a score component of the set of score components. In yet another example, the set of operations further comprises: receiving an indication to perform an action based on the provided indication; and in response to the indication, performing at least one action of: patching an instance of software; upgrading an instance of software; downgrading an instance of software; disabling a service; generating a knowledge article in a known error database comprising an indication to avoid functionality; or moving a workload to a different computing device. In a further still example, the at least on action is performed in response to receiving approval from a user to perform the at least one action.

In a further aspect, the technology relates to a method for managing at least one of hardware or software of an environment. The method comprises: receiving, from a computing device, a score request for at least one of hardware or software of the environment, wherein the hardware or software has a corresponding version; identifying a set of issues associated with the version, wherein the set of issues includes two or more of a confidentiality issue, an integrity issue, and an availability issue; generating an aggregated score for the version based on the set of issues; and providing, to the computing device in response to the score request, an indication of the aggregated score for the version. In an example, providing the indication of the aggregated score further comprises providing an indication of at least one issue of the identified set of issues. In another example, the aggregated score is generated based on one or more of: a confidentiality score component for the confidentiality issue; an integrity score component for the integrity issue; and an availability score component for the availability issue. In a further example, the aggregated score is generated based on a set of user-configured weights including at least one of: a first weight for the confidentiality score component; a second weight for the integrity score component; and a third weight for the availability score component. In yet another example, the set of issues relates to at least one of: a vulnerability for the version; or an operational defect for the version. In a further still example, the aggregated score is generated based on information obtained from at least one of: a vendor of the hardware or the software; a centralized data source; or a crowd-sourced data source. In another example, the score request is received as part of a change management process corresponding to the environment.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining customer information indicating at least one of hardware or software, wherein the hardware or software has a corresponding version;
identifying a set of issues associated with the version, wherein the set of issues includes two or more of a confidentiality issue, an integrity issue, and an availability issue;
generating an aggregated score for the version based on the set of issues; and
providing an indication of the aggregated score for the version.

2. The system of claim 1, wherein providing the indication of the aggregated score further comprises providing an indication of at least one issue of the identified set of issues.

3. The system of claim 1, wherein the aggregated score is generated based on one or more of:
a confidentiality score component for the confidentiality issue;
an integrity score component for the integrity issue; and
an availability score component for the availability issue.

4. The system of claim 3, wherein the aggregated score is generated based on a set of user-configured weights including at least one of:
a first weight for the confidentiality score component;
a second weight for the integrity score component; and
a third weight for the availability score component.

5. The system of claim 1, wherein the set of issues relates to at least one of:
a vulnerability for the version; or
an operational defect for the version.

6. The system of claim 1, wherein the aggregated score is generated based on information obtained from at least one of:
a vendor of the hardware or the software;
a centralized data source; or
a crowd-sourced data source.

7. The system of claim 1, wherein:
the customer information is obtained as part of a request, from a computing device, for an issue score associated with the at least one of hardware or software; and
the set of operations further comprises providing the indication of the aggregated score for the version to the computing device in response to the request.

8. A system comprising:
at least one processor; and
memory storing instructions that, when executed by the at least one processor, causes the system to perform a set of operations, the set of operations comprising:
receiving a recommendation request comprising an indication of at least one of computer software or computer hardware;
identifying, based on the recommendation request, a set of versions;
generating, for each version of the set of versions, an aggregated score;
ranking the set of versions based on an associated aggregated score for each version; and
providing an indication of a highest-ranked version from the ranked set of versions.

9. The system of claim 8, wherein providing the indication of the highest-ranked version further comprises providing an indication of an aggregated score for the highest ranked version.

10. The system of claim 8, wherein providing the indication of the highest-ranked version further comprises providing an indication of a set of score components used to generate the aggregated score for the highest-ranked version.

11. The system of claim 8, wherein generating the aggregated score for each version comprises:
determining set of score components comprising two or more of:
a confidentiality score component for the version;
an integrity score component for the version; and
an availability score component for the version; and
generating the aggregated score based on a set of user-configurable weights, wherein each weight of the set of user-configurable weights corresponds to a score component of the set of score components.

12. The system of claim 8, wherein the set of operations further comprises:
receiving an indication to perform an action based on the provided indication; and
in response to the indication, performing at least one action of:
patching an instance of software;
upgrading an instance of software;
downgrading an instance of software;
disabling a service;
generating a knowledge article in a known error database comprising an indication to avoid functionality; or
moving a workload to a different computing device.

13. The system of claim 12, wherein the at least on action is performed in response to receiving approval from a user to perform the at least one action.

14. A method for managing at least one of hardware or software of an environment, the method comprising:
receiving, from a computing device, a score request for at least one of hardware or software of the environment, wherein the hardware or software has a corresponding version;
identifying a set of issues associated with the version, wherein the set of issues includes two or more of a confidentiality issue, an integrity issue, and an availability issue;
generating an aggregated score for the version based on the set of issues; and
providing, to the computing device in response to the score request, an indication of the aggregated score for the version.

15. The method of claim 14, wherein providing the indication of the aggregated score further comprises providing an indication of at least one issue of the identified set of issues.

16. The method of claim 14, wherein the aggregated score is generated based on one or more of:
a confidentiality score component for the confidentiality issue;
an integrity score component for the integrity issue; and
an availability score component for the availability issue.

17. The method of claim 16, wherein the aggregated score is generated based on a set of user-configured weights including at least one of:
a first weight for the confidentiality score component;
a second weight for the integrity score component; and
a third weight for the availability score component.

18. The method of claim 14, wherein the set of issues relates to at least one of:
a vulnerability for the version; or
an operational defect for the version.

19. The method of claim 14, wherein the aggregated score is generated based on information obtained from at least one of:
a vendor of the hardware or the software;
a centralized data source; or
a crowd-sourced data source.

20. The method of claim 14, wherein the score request is received as part of a change management process corresponding to the environment.
